(19) United States
(12) Patent Application Publication
(10) Pub. No.: US 2026/0126299 A1
(43) Pub. Date: May 7, 2026

(54) AREA BOUNDARY LINE GENERATION METHOD, GROUND MOBILE ROBOT, AND STORAGE MEDIUM

(71) Applicant: JIANGSU DONGCHENG M&E TOOLS CO., LTD., NANTONG (CN)

(72) Inventors: CHONG WU, NANTONG (CN); YUNBO HONG, NANTONG (CN)

(21) Appl. No.: 19/435,701

(22) Filed: Dec. 29, 2025

Related U.S. Application Data
(63) Continuation of application No. PCT/CN2024/126553, filed on Oct. 22, 2024.

(30) Foreign Application Priority Data
Dec. 29, 2023 (CN) 202311870841.3

(51) Int. Cl. G01C 21/00; G05D 1/648; G05D 105/10; G05D 105/15; G05D 107/20

(52) U.S. Cl. CPC G01C 21/3807; G05D 1/648; G05D 2105/10; G05D 2105/15; G05D 2107/23

(57) ABSTRACT

The present disclosure relates to the technical field of image processing, and provides a method for generating a boundary line of an area, a ground mobile robot, and a storage medium. The method includes: determining sub-boundary lines one by one according to a predetermined strategy, each respective sub-boundary line having an identical or different length, where the predetermined strategy includes: acquiring boundary points sequentially one by one, and determining a start point and an end point of the respective sub-boundary line based on at least one of an angle and a height of a shape formed by respective boundary points of the boundary points; and performing linear fitting on boundary points between the start point and the end point to obtain the respective sub-boundary line, wherein the shape is a triangle.

### CROSS REFERENCE TO RELATED APPLICATIONS

The present application is a continuation of PCT Patent Application No. PCT/CN2024/126553, entitled “AREA BOUNDARY LINE GENERATION METHOD, GROUND MOBILE ROBOT, AND STORAGE MEDIUM,” filed Oct. 22, 2024, which claims priority to Chinese patent application No. 202311870841.3, entitled “AREA BOUNDARY LINE GENERATION METHOD, GROUND MOBILE ROBOT, AND STORAGE MEDIUM,” filed Dec. 29, 2023, each of which is incorporated by reference herein in its entirety.

### TECHNICAL FIELD

Embodiments of the present disclosure relate to the technical field of image processing, and more specifically to an area boundary line generation method, a ground mobile robot, and a storage medium.

### BACKGROUND

Ground mobile robots such as intelligent lawn mowers and intelligent floor sweepers liberate users' hands by eliminating the need for direct manual operation, thereby improving work efficiency and gaining increasing popularity. Currently, to enable more rational work planning for such a ground mobile robot, it is necessary to determine its working area prior to operation to prevent exceeding the boundary during work, that is, the ground mobile robot requires map construction for the working area.

### SUMMARY

Embodiments of the present disclosure provide an area boundary line generation method, a ground mobile robot, and a storage medium, enabling the ground mobile robot to obtain an area boundary line more rapidly and accurately.

The embodiments of the present disclosure provide a method for generating a boundary line of an area, applied to a ground mobile robot, where the boundary line includes a plurality of sub-boundary lines, and the method includes: determining sub-boundary lines one by one according to a predetermined strategy, each respective sub-boundary line having an identical or different length; the predetermined strategy includes: acquiring boundary points sequentially one by one, and determining a start point and an end point of the respective sub-boundary line based on at least one of an angle and a height of a shape formed by respective boundary points of the boundary points; and performing linear fitting on boundary points between the start point and the end point to obtain the respective sub-boundary line.

The present disclosure further provides a ground mobile robot, including: at least one processor; and a memory, communicatively connected to the at least one processor. The memory stores instructions executable by the at least one processor, and the instructions are configured to cause, when executed by the at least one processor, the at least one processor to execute the method for generating the boundary line of the area in any of the above embodiments.

The present disclosure further provides a computer-readable storage medium storing a computer program, where the computer program is configured to implement, when executed by a processor, the method for generating the boundary line of the area in any of the above embodiments.

### BRIEF DESCRIPTION OF THE DRAWINGS

One or more embodiments are exemplarily described with reference to the corresponding figures in the accompanying drawings, and the descriptions are not to be construed as limiting the embodiments.

FIG. 1 is a flowchart of a first area boundary line generation method provided by embodiments of the present disclosure.

FIG. 2 is a flowchart of a second area boundary line generation method provided by embodiments of the present disclosure.

FIG. 3 is a flowchart of a third area boundary line generation method provided by embodiments of the present disclosure.

FIG. 4 is a flowchart of a fourth area boundary line generation method provided by embodiments of the present disclosure.

FIG. 5 is a schematic diagram of multiple boundary points provided by embodiments of the present disclosure.

FIG. 6 is a schematic diagram of an area boundary line generation apparatus provided by embodiments of the present disclosure.

FIG. 7 is a structural schematic diagram of a ground mobile robot provided by embodiments of the present disclosure.

### DETAILED DESCRIPTION OF THE EMBODIMENTS

To make the objects, technical solutions and advantages of the present disclosure clearer, embodiments of the present disclosure are described in detail below in conjunction with the accompanying drawings. Those of ordinary skill in the art should appreciate that in embodiments of the present disclosure, numerous technical details have been presented to enable better understanding of the present disclosure. However, even without these technical details and various variations and modifications based on the following embodiments, the technical solutions claimed in the present disclosure can be realized. The division of the following embodiments is for descriptive convenience and shall not constitute any limitation on specific implementation manners of the present disclosure. The embodiments can be combined and cross-referenced with each other without contradiction.

Ground mobile robots such as lawn mowers and floor-cleaning robots require determination of a working area before performing tasks, enabling automated work based on the boundary of the working area to prevent the ground mobile robot exceeding the boundary during performing tasks. However, if the ground mobile robot consumes excessive time or exhibits low accuracy during map construction, work efficiency is affected, and user experience is degraded.

To address the above technical problem, embodiments of the present disclosure relate to a method for generating a boundary line of a working area, applied to a ground mobile robot. The method includes: determining sub-boundary lines one by one according to a predetermined strategy, each respective sub-boundary line having an identical or different length.

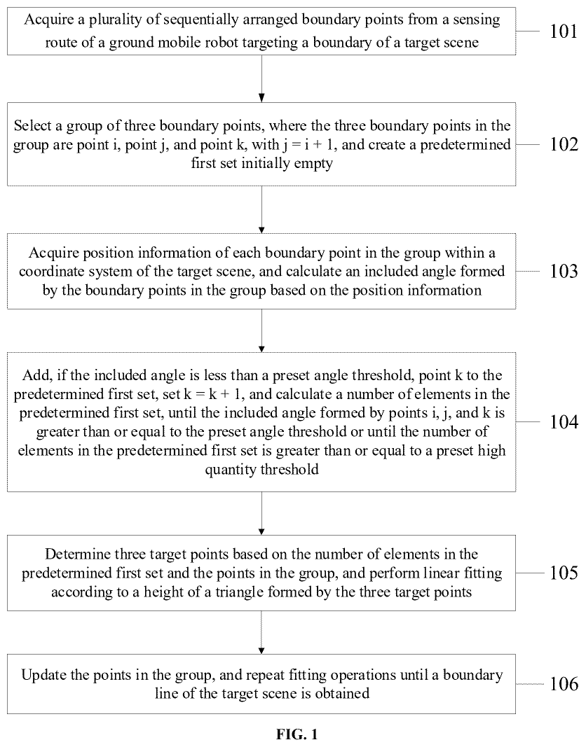

The predetermined strategy includes: the ground mobile robot acquiring boundary points sequentially one by one, determining a start point and an end point of the respective sub-boundary line based on at least one of an angle and a height of a shape formed by the boundary points, and performing linear fitting on boundary points between the start point and the end point to obtain the sub-boundary line. As shown in FIG. 1, the method includes operations described below.

In operation 101, multiple boundary points in sequence are obtained from the ground mobile robot's sensing route along the boundary of the target working area.

In the embodiments of the present disclosure, a boundary line may be provided in the target area. The ground mobile robot identifies the boundary line via its sensor, executes turning and advancing operations, and thereby forms the sensing route of the ground mobile robot targeting the boundary of the target area. For example, the ground mobile robot may depart from a charging dock, circumnavigate the area, and return to the charging dock to stop, which process is defined as a mapping procedure.

After obtaining the sensing route, multiple boundary points in sequence are acquired based on the sensing route. The acquisition method may include obtaining boundary points separated by a preset interval distance, obtaining boundary points separated by a preset interval time, or another acquisition method, which is not limited in the embodiments of the present disclosure. An initial boundary point and a final boundary point may each correspond to a location of the charging dock.

In operation 102, a group of three boundary points is selected, where the consecutive three boundary points in the group are point i, point j, and point k, with j=i+1, and a predetermined first set initially empty is created.

In an exemplary implementation, the consecutive three boundary points may be the first three boundary points of the sequentially arranged boundary points, that is, let i=1, j=i+1=2, and k=j+1=3. Alternatively, other consecutive boundary points may be selected, such as i=3, j=4, and k=5, which is not limited in the embodiments of the present disclosure.

In operation 103, position information of each boundary point in the group within a coordinate system of the target area is acquired, and an included angle formed by the boundary points in the group is calculated based on the position information.

In an exemplary implementation, during the mapping procedure, a wheel encoder of the ground mobile robot records a number of wheel rotations, and a wheel diameter is known. Therefore, position information of the ground mobile robot in the coordinate system of the target area can be calculated according to a differential drive motion model for motion of the ground mobile robot, and may be expressed as P(x, y).

The coordinate system of the target scene may be a world coordinate system. The ground mobile robot transforms trajectory data collected by the wheel encoder from a robot coordinate system to the world coordinate system, forming a unified reference. Each of these boundary points represents a position of the ground mobile robot in the world coordinate system at a respective time instant, and sequence numbers of trajectory points are consecutive. Thus, position information of each boundary point in the group in the world coordinate system is acquired, and the included angle formed by the points in the group is calculated based on the position information.

In an exemplary implementation, calculating the included angle formed by three points in the group within the world coordinate system may be performed through a predetermined calculation formula, with specific calculation as shown in Formula (1) below.

$$θ = abs ( atan ( ( t 1 - t 2 ) / ( 1 + t 1 * t 2 ) ) ) \qquad Formula ( 1 )$$

In Formula (1), θ represents the included angle formed by the three points in the world coordinate system, t1 and t2 respectively represent slopes corresponding to two angles a and b formed by the three points in the world coordinate system, abs( ) is a function for obtaining an absolute value, and atan( ) is a function for obtaining an arc tangent. In embodiments of the present disclosure, obtaining an absolute value via abs( ) is employed because an angle may be positive or negative, but regardless of being positive or negative, only an absolute value less than a preset angle threshold is required, thus the absolute value function is selected in the present disclosure.

In operation 104, if the included angle is less than a preset angle threshold, point k is added to the predetermined first set, it is set that k=k+1, and a number of elements in the predetermined first set is calculated, until the included angle formed by points i, j, and k (i.e., an angle between a line connecting point i to point j and a line connecting point i to point k, or called an angle at a start point (i.e., point i) of a shape formed by the points i, j, and k) is greater than or equal to the preset angle threshold. That is, when a number of boundary points on the sub-boundary line is not less than a preset value (namely, a preset low quantity threshold), an angle at a start point of a shape formed by the boundary points is less than or equal to a preset angle value.

The predetermined first set may be expressed as set A. If the included angle is less than the preset angle threshold, point k is added to the predetermined first set. In the embodiments of the present disclosure, position information of point k may be added to the predetermined first set A.

After point k is added to the predetermined first set A, let k=k+1, thereby shifting point k backward by one position. For example, if k currently represents the third point of the sequentially arranged boundary points, after being shifted backward by one position, the new point k becomes the fourth point of the sequentially arranged boundary points. Calculation of the included angle formed by point i, point j, and the new point k is continued. If the included angle at this time is greater than or equal to the preset angle threshold, the number of elements in the predetermined first set A is calculated. Conversely, if the included angle at this time remains less than the preset angle threshold, the new point k is continuously added to the predetermined first set A, k is set to k+1, thereby shifting the new point k backward by one position again, and the number of elements in the predetermined first set is calculated. These operations are repeated until the included angle formed by point i, point j, and the new point k is greater than or equal to the preset angle threshold, or until the number of elements in the predetermined first set is greater than or equal to a preset high quantity threshold.

In operation 105, three target points are determined based on the number of elements in the predetermined first set and points in the group, and linear fitting is performed according to a height of a triangle formed by the three target points.

The three target points are determined based on the points within the group (point i, point j, point k). The determined three target points differ depending on the number of elements in the predetermined first set. Moreover, the height of the triangle formed by the three target points determines a method for the linear fitting.

In the embodiments of the present disclosure, a preliminary judgment based on angle is performed on consecutive points, then a height of a triangle constituted in a different manner based on the number of points in the predetermined first set A is utilized to determine whether a current angle result is over-fitting or incorrect-fitting, and different calibration procedures are adopted according to different schemes. If the angle result is neither over-fitting nor incorrect-fitting, it is a correct linear fitting satisfying conditions, and the fitting result is saved.

In operation 106, the points in the group are updated, and the fitting operations are repeated until a boundary line of the target area is obtained.

Based on the method of linear fitting, a corresponding point update method is selected to update points in the group, resulting in updated points in the group. Subsequently, fitting operations are continued based on the updated points in the group.

In an exemplary implementation, when initial points i, j, and k are the first, second, and third points of the sequentially arranged boundary points respectively, and if point k is the last boundary point of the sequentially arranged boundary points, the linear fitting is completed to obtain the boundary line of the target area. The boundary line of the target area is represented as a polygon.

The solution of the present disclosure provides a linear fitting method based on angle and height. By introducing judgment of a triangle height, concentrated fitting caused by an insufficient number of point sets is avoided, and errors caused by excessively long segments are also prevented, achieving faster and more accurate linear fitting. The linear fitting method integrating angle and triangle height enables an area boundary generation method to operate at higher speed while generating an area boundary with higher accuracy and fewer fitting points. Furthermore, line segments formed by connecting every two of the three points are not collinear, thus indicating the presence of an inflection point, in particular, a point between adjacent sub-boundary lines. That is, connected sub-boundary lines not being collinear, indicate that the point between such adjacent sub-boundary lines is an inflection point.

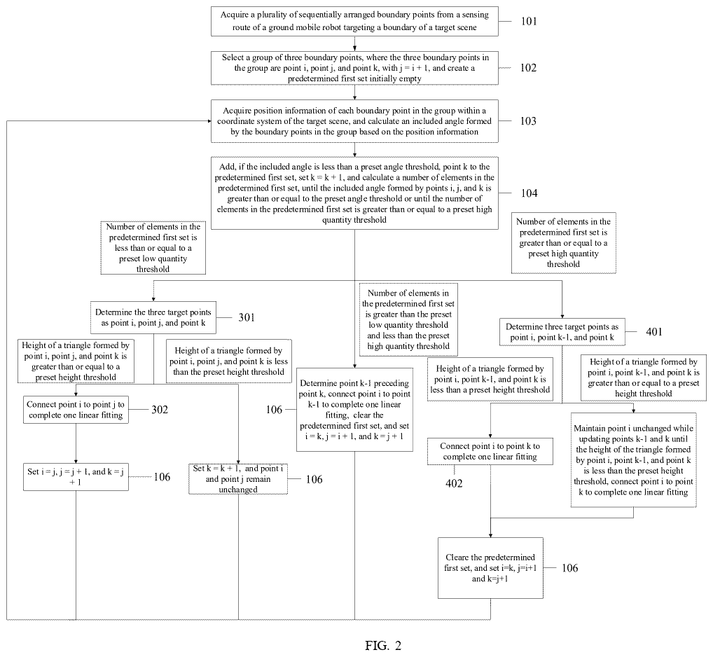

Based on the embodiments described in FIG. 1 above, the embodiments of the present disclosure further provide another area boundary line generation method, as shown in FIGS. 2 and 3. In the operation 105, determining the three target points based on the number of elements in the predetermined first set and the points in the group, and performing linear fitting according to the height of the triangle formed by the three target points may include operations described below

In operation 301, if a number of elements in the predetermined first set is less than or equal to a preset low quantity threshold, the three target points are determined as point i, point j, and point k.

The preset low quantity threshold is a fixed value preset by the ground mobile robot.

In operation 302, if a height of a triangle formed by point i, point j, and point k is greater than or equal to a preset height threshold, points i and j are connected, completing one linear fitting.

In the embodiments of the present disclosure, the height of the triangle is a height on a longest side of the triangle. Alternatively, the height may correspond to another side, which is not limited in the embodiments of the present disclosure.

In a special case, if the number of elements in the predetermined first set equals 3 and is less than or equal to the preset low quantity threshold, and an angle between a line connecting point i to point j and a line connecting point i to point k is greater than the preset angle threshold, point i is connected to point j without performing judgment based on triangle height, completing one linear fitting.

In the above operation 106, updating the points in the group includes: setting i=j, j=j+1, and k=j+1, that is, taking point j as a new point i, a next point after the new point i as a new point j, and a next point after the new point j as a new point k.

In an exemplary implementation, when points i, j, and k are the fifth, sixth, and seventh points of the sequentially arranged boundary points respectively, the updated points in the group may be the sixth, seventh, and eighth points of the sequentially arranged multiple boundary points respectively.

This update method is only applicable to the case where the number of elements in the predetermined first set is less than or equal to the preset low quantity threshold and the height of the triangle formed by points i, j, and k is greater than or equal to the preset height threshold.

In the solution of the present disclosure, if a number of boundary points on the sub-boundary line is less than a preset value, a height of a shape formed by a start point and an end point of the sub-boundary line together with a boundary point on a next sub-boundary line is greater than a preset height value, where the end point of the sub-boundary line serves as a start point of the next sub-boundary line, and the boundary point on the next sub-boundary line is a next boundary point located after the start point of the next sub-boundary line. That is, in the case where the number of elements in the predetermined first set is less than or equal to the preset low quantity threshold and the height of the triangle formed by points i, j, and k is greater than or equal to the preset height threshold, fitting conditions are satisfied. One linear fitting is completed by connecting point i to point j, then points in the group are updated through a corresponding update method, and fitting operations are subsequently continued, thereby achieving linear fitting in the specific case.

Based on the embodiments described in FIG. 3 above, the embodiments of the present disclosure further provide another area boundary line generation method, as shown in FIG. 2, which specifically includes the following operations.

If a height of a triangle formed by point i, point j, and point k is less than a preset height threshold, in the above operation 106, updating the points in the group includes setting k=k+1, that is, shifting point k backward by one position, while point i and point j remain unchanged. That is, a height of a shape formed by a start point and an end point of the sub-boundary line together with a boundary point between the start point and the end point of the sub-boundary line is not greater than the preset height value.

In the embodiments of the present disclosure, if the height of the triangle formed by point i, point j, and point k is less than the preset height threshold, it is indicated that the current angle fitting is unsuccessful and results from over-fitting caused by insufficient data and excessively short segments, thus requiring discarding.

In an exemplary implementation, when points i, j, and k are the fifth, sixth, and ninth points of the sequentially arranged boundary points respectively, the updated points in the group may be the fifth, sixth, and tenth points of the sequentially arranged boundary points respectively, where positions of point i and point j remain unchanged.

This update method is applicable only to the case where the number of elements in the predetermined first set is less than or equal to the preset low quantity threshold and the height of the triangle formed by points i, j, and k is less than the preset height threshold.

In the solution of the present disclosure, in the case where the number of elements in the predetermined first set is less than or equal to the preset low quantity threshold and the height of the triangle formed by points i, j, and k is less than the preset height threshold, the fitting conditions are not satisfied. Points in the group are updated through a corresponding update method, and fitting operations are subsequently continued, thereby achieving judgment of linear fitting in the specific case.

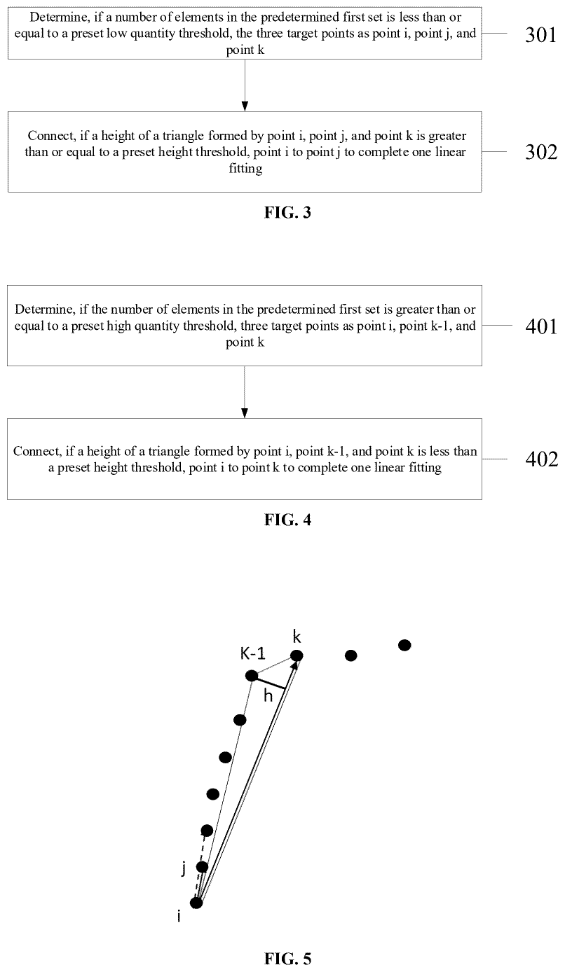

Based on the embodiments described in FIG. 1 above, the embodiments of the present disclosure further provide another area boundary line generation method, as shown in FIGS. 4 and 2. In the above operation 105, determining the three target points based on the number of elements in the predetermined first set and the points in the group and performing linear fitting according to the height of the triangle formed by the three target points may include operations described below.

In operation 401, if the number of elements in the predetermined first set is greater than or equal to a preset high quantity threshold, that is, if the number of boundary points on the sub-boundary line is greater than or equal to a preset maximum value, three target points are determined as point i, point k−1, and point k.

In the embodiments of the present disclosure, the preset high quantity threshold is greater than the preset low quantity threshold, and is a fixed value preset by the ground mobile robot.

Point k−1 is a point immediately preceding point k. For example, when point k is the fifth point of the sequentially arranged boundary points, point k−1 is the fourth point of the sequentially arranged boundary points.

In operation 402, if a height of a triangle formed by point i, point k−1, and point k is less than a preset height threshold, point i is connected to point k, completing one linear fitting.

If the height of the triangle formed by point i, point k−1, and point k is less than the preset height threshold, it is determined that fitting conditions are satisfied, thus enabling connection of point i to point k to complete one linear fitting.

In the above operation 106, updating the points in the group includes: clearing the predetermined first set, and setting i=k, j=i+1 and k=j+1, that is, taking point k as a new point i, a next point after the new point i as a new point j, and a next point after the new point j as a new point k.

If one linear fitting is completed, the points in the predetermined first set are added to a predetermined second set, then points in the predetermined first set are cleared, and after clearing, points in the group continue to be updated.

In an exemplary implementation, when points i, j, and k are the fifth, sixth, and ninth points of the sequentially arranged boundary points respectively, the updated points in the group may be the ninth, tenth, and eleventh points of the multiple boundary points respectively.

This update method is applicable only to the case where the number of elements in the predetermined first set is greater than or equal to the preset high quantity threshold and the height of the triangle formed by point i, point k−1, and point k is less than the preset height threshold.

In the solution of the present disclosure, in the case where the number of elements in the predetermined first set is greater than or equal to the preset high quantity threshold and the height of the triangle formed by point i, point k−1, and point k is less than the preset height threshold, the fitting conditions are satisfied. One linear fitting is completed by connecting point i to point k, then points in the group are updated through a corresponding update method, and fitting operations are subsequently continued, thereby achieving judgment of linear fitting in the specific case.

Based on the embodiments described in FIG. 3 above, the embodiments of the present disclosure further provide another area boundary line generation method, as shown in FIG. 2, which specifically includes the following operations.

If a height of a triangle formed by point i, point k−1, and point k is greater than or equal to a preset height threshold, point i is maintained unchanged while points k−1 and k are updated until the height of the triangle formed by point i, point k−1, and point k is less than the preset height threshold. Point i is connected to point k, completing one linear fitting. Then, the points in the group are updated, including clearing the predetermined first set, and setting i=k, j=i+1, and k=j+1.

In the embodiments of the present disclosure, if the height of the triangle formed by point i, point k−1, and point k is greater than or equal to the preset height threshold, it is indicated that the current angle fitting is unsuccessful, requiring updating of the points for subsequent linear fitting.

The principle for updating points here is setting k=k−1, that is, taking point k−1 as a new point k, where a new point k−1 is a point immediately preceding the new point k.

If points i, k−1, and k are the third, sixth, and seventh points of the sequentially arranged boundary points respectively, the updated points may be the third, fifth, and sixth points of the sequentially arranged boundary points respectively, where a position of point i remains unchanged.

If a height of a triangle formed by the updated points i, k−1, and k is less than the preset height threshold, point i is connected to point k, completing one linear fitting, and angle judgment is subsequently continued. Otherwise, if the height of the triangle formed by the updated points i, k−1, and k is greater than or equal to the preset height threshold, updating is continued until the height of the triangle formed by the updated points i, k−1, and k is less than the preset height threshold. Then, point i is connected to point k, completing one linear fitting, and after updating the points in the group, angle judgment is subsequently continued.

This update method is applicable only to the case where the number of elements in the predetermined first set is greater than or equal to the preset high quantity threshold, and the height of the triangle formed by point i, point k−1, and point k is greater than or equal to the preset height threshold.

In the solution of the present disclosure, in the case where the number of elements in the predetermined first set is greater than or equal to the preset high quantity threshold and the height of the triangle formed by point i, point k−1, and point k is greater than or equal to the preset height threshold, fitting conditions are not satisfied. Through updating points in the group, points i, k−1, and k are caused to satisfy fitting conditions, then point i is connected to point k, completing one linear fitting, and updating operations are subsequently continued, thereby achieving linear fitting in the specific case.

Based on the embodiments described in FIG. 1 above, the embodiments of the present disclosure further provide another area boundary line generation method, as shown in FIG. 2. In the above operation 105, determining the three target points based on the number of elements in the predetermined first set and the points in the group and performing linear fitting according to the height of the triangle formed by the three target points may include the following operations.

If the number of elements in the predetermined first set is greater than the preset low quantity threshold and less than the preset high quantity threshold, a point k−1 preceding point k is determined, and then point i is connected to k−1, completing one linear fitting.

In the embodiments of the present disclosure, if the number of elements in the predetermined first set is between the preset low quantity threshold and the preset high quantity threshold, point i is connected to point k−1, completing one linear fitting without performing judgment based on triangle height, thereby reducing unnecessary computational load and improving judgment efficiency.

In the above operation 106, updating the points in the group includes clearing the predetermined first set, and setting i=k−1, j=i+1, and k=j+1, that is, taking point k−1 as a new point i, a next point after the new point i as a new point j, and a next point after the new point j as a new point k.

In the solution of the present disclosure, when the number of elements in the predetermined first set is greater than the preset low quantity threshold and less than the preset high quantity threshold, it is determined that fitting conditions are satisfied through angle judgment, points i and k−1 are fitted, and points in the group are updated, thereby reducing computation time for judgment based on triangle height and improving fitting efficiency.

Based on the embodiments described above, the embodiments of the present disclosure provide a specific example to further explain the solution of the present disclosure, as shown in FIG. 5.

After initial points i, j, and k undergo judgment of an included angle against the preset angle threshold, the included angle formed by points i, j, and k shown in FIG. 5 is greater than or equal to the preset angle threshold. At this time, the number of elements in the predetermined first set is 5, which is greater than or equal to the preset high quantity threshold, and then three target points are determined as point i, point k−1, and point k. A height h of a triangle formed by point i, point k−1, and point k is calculated and is less than a preset height threshold, and point i is connected to point k, completing one linear fitting. The predetermined first set is cleared, it is set that i=k, j=i+1, and k=j+1, that is, point k is taken as a new point i, a next point after the new point i is taken as a new point j, and a next point after the new point j is taken as a new point k. Fitting operations are then continued.

For the sub-boundary lines obtained by the method in the present disclosure, when a number of boundary points on a respective sub-boundary line is not less than a preset value (i.e., a preset low quantity threshold), an angle at a start point of a shape formed by the boundary points is less than or equal to a preset angle value.

The solution of the present disclosure provides a linear fitting method integrating angle and height, where the angle-based linear fitting method involves lower computational load, and the triangle height-based linear fitting method ensures accurate fitting results. Thereby, the area boundary generation method achieves faster generation speed while generating the area boundary with higher accuracy and fewer fitting points.

The division of operations in the various methods above is for clarity of description only. During implementation, operations may be combined into a single operation or split into multiple operations, provided that the same logical relationship is maintained, all falling within the protection scope of the present disclosure. Insignificant modifications or additions to the algorithm or flow that do not alter its core design also fall within the protection scope of the present disclosure.

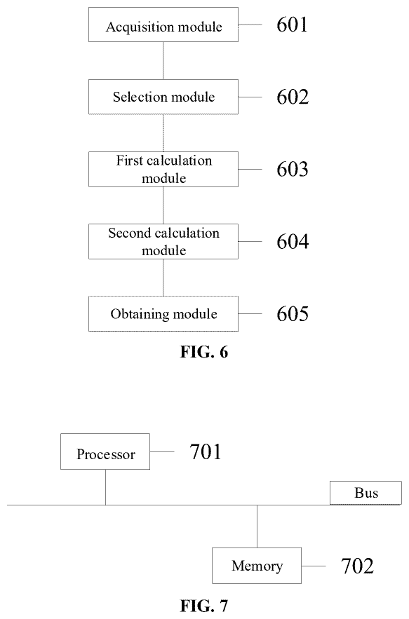

Embodiments of the present disclosure relate to an area boundary line generation apparatus. Details of the area boundary line generation apparatus according to this embodiment are specifically described below. The following content is provided for ease of understanding and represents implementation details that are not essential for practicing this embodiment. FIG. 6 is a schematic diagram of an area boundary line generation apparatus provided by the embodiments of the present disclosure, including an acquisition module 601, a selection module 602, a first calculation module 603, a second calculation module 604, and an obtaining module 605.

The acquisition module 601 is configured to acquire a plurality of sequentially arranged boundary points from a sensing route of a ground mobile robot targeting a boundary of a target area.

The selection module 602 is configured to select a group of three boundary points, where the three boundary points in the group are point i, point j, and point k, with j=i+1, and create a predetermined first set initially empty.

The first calculation module 603 is configured to acquire position information of each boundary point in the group within a coordinate system of the target area, and calculate an included angle formed by the boundary points in the group based on the position information.

The second calculation module 604 is configured to add, if the included angle is less than a preset angle threshold, point k to the predetermined first set, set k=k+1, and calculate a number of elements in the predetermined first set, until the included angle formed by points i, j, and k is greater than or equal to the preset angle threshold or until the number of elements in the predetermined first set is greater than or equal to a preset high quantity threshold.

The obtaining module 605 is configured to determine three target points based on the number of elements in the predetermined first set and the points in the group, perform linear fitting according to a height of a triangle formed by the three target points, update the points in the group, and repeat fitting operations until a boundary line of the target area is obtained.

In an embodiment, the obtaining module 605 is configured to determine, if a number of elements in the predetermined first set is less than or equal to a preset low quantity threshold, the three target points as point i, point j, and point k, connect, if a height of a triangle formed by point i, point j, and point k is greater than or equal to a preset height threshold, point i to point j to complete one linear fitting, and update the points in the group. Updating the points in the group includes setting i=j, j=j+1, and k=j+1, that is, taking point j as a new point i, a next point after the new point i as a new point j, and a next point after the new point j as a new point k.

In an embodiment, the obtaining module 605 is further configured to not perform linear fitting if a height of a triangle formed by point i, point j, and point k is less than the preset height threshold, and update the points in the group. Updating the points in the group include setting k=k+1, that is, shifting point k backward by one position, while point i and point j remain unchanged.

In an embodiment, the obtaining module 605 is configured to determine, if the number of elements in the predetermined first set is greater than or equal to a preset high quantity threshold, three target points as point i, point k−1, and point k, connect, if a height of a triangle formed by point i, point k−1, and point k is less than a preset height threshold, point i to point k to complete one linear fitting, and update the points in the group. Updating the points in the group includes: clearing the predetermined first set, and setting i=k, j=i+1 and k=j+1, that is, taking point k as a new point i, a next point after the new point i as a new point j, and a next point after the new point j as a new point k.

In an embodiment, the obtaining module 605 is configured to maintain, if a height of a triangle formed by point i, point k−1, and point k is greater than or equal to a preset height threshold, point i unchanged while updating points k−1 and k until the height of the triangle formed by point i, point k−1, and point k is less than the preset height threshold, connect point i to point k to complete one linear fitting, and then update the points in the group. Update the points in the group includes: clearing the predetermined first set, and setting i=k−1, j=i+1, and k=j+1, that is, taking point k−1 as a new point i, a next point after the new point i as a new point j, and a next point after the new point j as a new point k.

In an embodiment, the obtaining module 605 is configured to determine, if the number of elements in the predetermined first set is greater than the preset low quantity threshold and less than the preset high quantity threshold, point k−1 preceding point k, connect point i to point k−1 to complete one linear fitting, and update the points in the group. Update the points in the group includes: clearing the predetermined first set, and setting i=k, j=i+1, and k=j+1. Updating points k−1 and k includes setting k=k−1, that is, taking point k−1 as a new point k, where a new point k−1 is a point immediately preceding the new point k.

In the embodiments of the present disclosure, if the number of elements in the predetermined first set is between the preset low quantity threshold and the preset high quantity threshold, point i is connected to point k−1, completing one linear fitting without performing judgment based on triangle height, thereby reducing unnecessary computational load and improving judgment efficiency.

In an embodiment, the acquisition module 601 is configured to perform sampling from a sensing route of the ground mobile robot targeting a boundary of a target area according to a preset interval distance to acquire a plurality of sequentially arranged boundary points.

It can be recognized that the present embodiments are apparatus embodiments corresponding to the above method embodiments, and can be implemented in cooperation with the above method embodiments. Related technical details and technical effects mentioned in the above embodiments remain effective in the present embodiments, and are not redundantly described here to avoid repetition. Correspondingly, related technical details mentioned in the present embodiments may also be applied in the above embodiments.

Embodiments of the present disclosure relate to a ground mobile robot, as shown in FIG. 7, including at least one processor 701, and a memory 702 communicatively connected to the at least one processor 701. The memory 702 stores instructions executable by the at least one processor 701, and the instructions are configured to cause, when executed by the at least one processor 701, the at least one processor 701 to execute the area boundary line generation method in the above various embodiments.

The memory 702 and the processor 701 are connected to each other by a bus, and the bus may include any number of interconnected buses and bridges. The bus connects various circuits of one or more processors and memories together. The bus may also connect various other circuits such as peripheral devices, which are well-known in the art, and therefore, are not further described herein.

Embodiments of the present disclosure relate to a computer-readable storage medium storing a computer program. The computer program is configured to implement, when executed by a processor, the method embodiments described above.

Those skilled in the art may understand that all or part of the operations of the method in the above embodiments may be implemented by a program instructing related hardware. The program is stored in a storage medium and includes several instructions to cause a device (which may be a single-chip microcomputer, a chip, or the like) or a processor to execute all or part of the operations of the method described in the various embodiments of the present disclosure. The aforementioned storage medium includes a U disk, a mobile hard disk, a read-only memory (ROM), a random access memory (RAM), a magnetic disk, an optical disk, or any other medium that can store program codes.

Those of ordinary skill in the art may understand that the above various embodiments are specific embodiments for implementing the present disclosure, and in practical applications, various changes may be made in form and detail without departing from the spirit and scope of the present disclosure.

What is claimed is:

1. A method for generating a boundary line of an area, the boundary line including a plurality of sub-boundary lines, and the method comprising:
determining sub-boundary lines one by one according to a predetermined strategy, each respective sub-boundary line of the plurality of sub-boundary lines having an identical or different length;
wherein the predetermined strategy includes:
acquiring boundary points sequentially one by one, and determining a start point and an end point of the respective sub-boundary line based on at least one of an angle and a height of a shape determined by respective boundary points of the boundary points; and
performing linear fitting on boundary points between the start point and the end point to obtain the respective sub-boundary line, wherein the shape is a triangle.

2. The method according to claim 1, wherein when a number of boundary points on the respective sub-boundary line is less than a preset value, a height of a shape formed by the start point and the end point of the respective sub-boundary line together with a boundary point on an adjacent next sub-boundary line is configured as greater than a preset height value.

3. The method according to claim 2, wherein the end point of the respective sub-boundary line is configured as the start point of the adjacent next sub-boundary line, and the boundary point on the adjacent next sub-boundary line is configured as an adjacent next boundary point located after the start point of the adjacent next sub-boundary line.

4. The method according to claim 1, wherein when a number of boundary points on the respective sub-boundary line is not less than a preset value, the angle at the start point of the shape formed by the boundary points is less than or equal to a preset angle value.

5. The method according to claim 1, wherein when a number of boundary points on the respective sub-boundary line is not less than a preset value, a height of a shape formed by the start point and the end point of the respective sub-boundary line together with the boundary point between the start point and the end point of the respective sub-boundary line is not greater than a preset height value.

6. The method according to claim 4, wherein a height of a shape formed by the start point and the end point of the respective sub-boundary line together with the boundary point on an adjacent next sub-boundary line is greater than a preset height value.

7. The method according to claim 4, wherein in a shape formed by the start point and the end point of the respective sub-boundary line together with a boundary point on an adjacent next sub-boundary line, the angle at the start point is greater than a preset angle value.

8. The method according to claim 4, wherein a number of boundary points on the respective sub-boundary line is greater than or equal to a preset maximum value.

9. The method according to claim 5, wherein the height of the shape is defined as a height value corresponding to a base line formed by connecting the start point and the end point of the respective boundary line.

10. The method according to claim 6, wherein the height of the shape is defined as a height value corresponding to a base line formed by connecting the start point and the end point of the respective boundary line.

11. The method according to claim 1, wherein there is an inflection point between adjacent sub-boundary lines.

12. The method according to claim 11, wherein acquiring the boundary points sequentially one by one comprise:
performing sampling from a sensing route of the ground mobile robot targeting a boundary of a target area according to a preset interval distance to acquire a plurality of sequentially arranged boundary points.

13. A ground mobile robot, comprising:
at least one processor; and
a memory, communicatively connected to the at least one processor;
wherein the memory stores instructions executable by the at least one processor, and the instructions are configured to cause, when executed by the at least one processor, the at least one processor to execute the method according to claim 1.

14. A non-transitory computer-readable storage medium storing a computer program, wherein the computer program is configured to implement, when executed by a processor, a method for generating a boundary line of an area, the boundary line including a plurality of sub-boundary lines, and the method including:
determining sub-boundary lines one by one according to a predetermined strategy, each respective sub-boundary line of the plurality of sub-boundary lines having an identical or different length;
wherein the predetermined strategy includes:
acquiring boundary points sequentially one by one, and determining a start point and an end point of the respective sub-boundary line based on at least one of an angle and a height of a shape determined by respective boundary points of the boundary points; and
performing linear fitting on boundary points between the start point and the end point to obtain the respective sub-boundary line wherein the shape is a triangle.

15. The non-transitory computer-readable storage medium according to claim 14, wherein when a number of boundary points on the respective sub-boundary line is less than a preset value, a height of a shape formed by the start point and the end point of the respective sub-boundary line together with a boundary point on an adjacent next sub-boundary line is configured as greater than a preset height value.

16. The non-transitory computer-readable storage medium according to claim 15, wherein the end point of the respective sub-boundary line is configured as the start point of the adjacent next sub-boundary line, and the boundary point on the adjacent next sub-boundary line is configured as an adjacent next boundary point located after the start point of the adjacent next sub-boundary line.

17. The non-transitory computer-readable storage medium according to claim 14, wherein when a number of boundary points on the respective sub-boundary line is not less than a preset value, the angle at the start point of the shape formed by the respective boundary points is less than or equal to a preset angle value.

18. The non-transitory computer-readable storage medium according to claim 14, wherein a height of a shape formed by the start point and the end point of the respective sub-boundary line together with the boundary point between the start point and the end point of the respective sub-boundary line is not greater than a preset height value.

19. The non-transitory computer-readable storage medium according to claim 17, wherein a height of a shape formed by the start point and the end point of the respective sub-boundary line together with the boundary point on an adjacent next sub-boundary line is greater than a preset height value.

20. The non-transitory computer-readable storage medium according to claim 17, wherein in a shape formed by the start point and the end point of the respective sub-boundary line together with the boundary point on an adjacent next sub-boundary line, the angle at the start point is greater than a preset angle value.
